(19) United States
(12) Patent Application Publication
(10) Pub. No.: US 2026/0318760 A1
(43) Pub. Date: Oct. 15, 2026

(54) SELF-DECOUPLING THREE-DIMENSIONAL FORCE MULTIMODAL SENSING DEVICE, SYSTEM AND METHOD BASED ON RADIAL MAGNETIZATION

(71) Applicant: SOUTHEAST UNIVERSITY, Jiangsu (CN)

(72) Inventors: Baoguo XU, Jiangsu (CN); Huan ZHU, Jiangsu (CN); Jiawei ZHANG, Jiangsu (CN); Huijun LI, Jiangsu (CN); Aiguo SONG, Jiangsu (CN)

(73) Assignee: SOUTHEAST UNIVERSITY, Jiangsu (CN)

(21) Appl. No.: 19/466,525

(22) Filed: Feb. 2, 2026

Related U.S. Application Data
(63) Continuation of application No. PCT/CN2025/090580, filed on Apr. 23, 2025.

(30) Foreign Application Priority Data
Feb. 21, 2025 (CN) 202510194714.9
Feb. 24, 2025 (CN) 202510201006.3

(51) Int. Cl. G01L 1/26; G01B 11/14; G01L 1/12

(52) U.S. Cl. CPC G01L 1/26; G01B 11/14; G01L 1/12

(57) ABSTRACT

A self-decoupling three-dimensional force multimodal sensing device based on radial magnetization includes a flexible magnetic film with radial magnetization, a microstructure layer, an optical waveguide layer, a housing, a visible-light camera, a Hall element, a printed circuit board (PCB), and an infrared camera, where the flexible magnetic film, the microstructure layer, the optical waveguide layer, and the housing are sequentially stacked from top to bottom. The PCB, the visible-light camera, and the infrared camera are all located on a bottom surface of the housing, and the Hall element is mounted on the PCB. A self-decoupling three-dimensional force multimodal sensing system based on radial magnetization includes the self-decoupling three-dimensional force multimodal sensing device and a signal processing device. The signal processing device can perform three-dimensional force decoupling, infrared distance sensing, and force application position measurement based on data from the PCB, the visible-light camera, and the infrared camera.

### CROSS-REFERENCE TO RELATED APPLICATION

This application is a continuation of International Application of PCT application serial no. PCT/CN2025/090580 filed on Apr. 23, 2025, which claims the priority benefit of China application serial no. 202510201006.3 filed on Feb. 24, 2025 and China application serial no. 202510194714.9 filed on Feb. 21, 2025. The entirety of each of the above-mentioned patent applications is hereby incorporated by reference herein and made a part of this specification.

### BACKGROUND

### Technical Field

The present disclosure relates to pressure sensing technology, and in particular to a self-decoupling three-dimensional force multimodal sensing device, system and method based on radial magnetization.

### Description of Related Art

The human hand is capable of recognizing texture, shape, and size to enable fine haptic feedback and daily manipulation, distinguishing between normal force and shear force and achieving ultra-high-resolution perception. Through haptic feedback, the posture of the fingers and the contact force can be dynamically adjusted. In recent years, various haptic sensors based on sensing principles have been provided, including capacitive, resistive, piezoelectric, magnetoelectric, and optical haptic sensors. Optical-based haptic sensors can achieve super-resolution comparable to that of human skin; however, they are generally large in size and mostly only capable of sensing normal force. With the development of materials science, the use of novel materials to fabricate electrodes has made the measurement of shear force possible. However, there exists a coupling relationship between normal force and shear force. Although a decoupling model between normal force and shear force can be established through calibration experiments, there are still significant challenges in practical applications. First, calibration experiments are required; second, a decoupling model needs to be fitted, making the entire process very complex and cumbersome. Moreover, existing three-dimensional force sensors are unable to achieve multimodal data sensing.

In summary, the current haptic sensors suffer from the following technical challenges: first, their resolutions are relatively low, and these sensors are unable to reach the resolution of human skin; second, there exists a coupling between normal force and shear force; and third, they are unable to achieve multimodal sensing.

### SUMMARY

To address the problems existing in the prior art, the present disclosure aims to provide a self-decoupling three-dimensional force multimodal sensing device, system and method based on radial magnetization.

In order to achieve the above objective, the present disclosure provides the following technical solutions:
a self-decoupling three-dimensional force multimodal sensing device based on radial magnetization includes a flexible magnetic film with radial magnetization, a microstructure layer, an optical waveguide layer, a housing, a Hall element, a printed circuit board (PCB), a visible-light camera, and an infrared camera. Specifically, the flexible magnetic film, the microstructure layer, the optical waveguide layer, and the housing are sequentially stacked from top to bottom. The PCB, the visible-light camera, and the infrared camera are all located on a bottom surface of the housing, and the Hall element is mounted on the PCB.

Further, centers of the flexible magnetic film, the microstructure layer, and the optical waveguide layer are aligned with a center of the Hall element along the same vertical line.

Further, the visible-light camera and the infrared camera are symmetrically arranged on opposite sides of the Hall element.

Further, the flexible magnetic film is fabricated from polydimethylsiloxane (PDMS) and neodymium-iron-boron (NdFeB) magnetic powder.

Further, the microstructure layer is made of silicone rubber with an inverted pyramid shape.

Further, the optical waveguide layer is made of polymethyl methacrylate (PMMA).

A self-decoupling three-dimensional force multimodal sensing system based on radial magnetization includes the above-mentioned self-decoupling three-dimensional force multimodal sensing device and a signal processing device, where the signal processing device specifically includes:
a data acquisition module configured to acquire a leaked-light spot image captured by the visible-light camera and an infrared light spot image captured by the infrared camera;
a force position acquisition module configured to calculate a position of a leaked-light spot center point in the leaked-light spot image on an imaging plane of the visible-light camera, and substitute a position of a current leaked-light spot center point on the imaging plane of the visible-light camera into a pre-stored relationship curve between a light spot center position and a force loading position, thereby obtaining a current force loading position;
an infrared distance sensing module configured to calculate an infrared light spot size in the infrared light spot image, and substitute a current infrared light spot size into a pre-stored relationship curve between the infrared light spot size and an infrared sensing distance, thereby obtaining a current infrared sensing distance; and
a three-dimensional force decoupling module configured to decouple a three-dimensional force according to the following formulas:

$${F}_{x} = \frac{S \cdot G}{k \cdot h} ( {tan}^{- 1} \frac{{R}_{xz} ( {x}_{i} ) - {b}_{1}}{{a}_{1}} - {tan}^{- 1} \frac{{R}_{xz} ( {x}_{0} ) - {b}_{1}}{{a}_{1}} )$$

$${F}_{y} = \frac{S \cdot G}{k \cdot h} ( {tan}^{- 1} \frac{{R}_{yz} ( {y}_{i} ) - {b}_{2}}{{a}_{2}} - {tan}^{- 1} \frac{{R}_{yz} ( {y}_{0} ) - {b}_{2}}{{a}_{2}} )$$

$${F}_{z} = \frac{S \cdot E}{k \cdot h} ln \frac{B ( {z}_{i} ) - {b}_{0}}{B ( {z}_{0} ) - {b}_{0}}$$

where Fₓ, F_{y} and F_{z} respectively denote forces in the x, y and z directions of the three-dimensional force, S denotes a contact area, G denotes a shear modulus, E denotes an elastic modulus, h denotes a distance from the upper surface of the flexible magnetic film to an upper surface of the PCB, k=2π/T denotes a wave number, T denotes a period, a₁, a₂ and b₀, b₁ and b₂ are pre-calibrated fitting coefficients, R_{xz}(xᵢ) and R_{xz}(x₀) respectively denote ratios of a magnetic flux density in an x direction to a magnetic flux density in a z direction when the flexible magnetic film is deformed to a position xᵢ under an x-direction force and when no force is applied, R_{yz}(yᵢ) and R_{yz}(y₀) respectively denote ratios of a magnetic flux density in a y direction to the magnetic flux density in the z direction when the flexible magnetic film is deformed to a position yᵢ under a y-direction force and when no force is applied, B(zᵢ) and B(z₀) respectively denote total magnetic flux densities when the flexible magnetic film is deformed to a position zᵢ under a z-direction force and when no force is applied, (x₀, y₀, z₀) denotes original coordinates of a center point of the flexible magnetic film when it is not subjected to a force, and (xᵢ, yᵢ, zᵢ) denotes coordinates of the center point of the flexible magnetic film after deformation under a three-dimensional force.

Further, the relationship curve between a light spot center position and a force loading position is obtained according to the following method:
establishing a coordinate system x′y′ by taking a center position of the upper surface of the flexible magnetic film as a coordinate origin;
establishing a coordinate system x′″y′″ by taking a center position of the imaging plane of the visible-light camera as a coordinate origin; and
calculating a coordinate transformation curve between the coordinate system x′″y′″ and the coordinate system x′y′ and taking the same as the relationship curve between a light spot center position and a force loading position.

Further, the relationship curve between the infrared light spot size and an infrared sensing distance is obtained according to the following method:
placing the same infrared sensing object at different distances from the upper surface of the flexible magnetic film, and acquiring infrared spot images when the infrared sensing object is placed;
calculating infrared light spot sizes in the infrared light spot images at different distances; and
performing fitting based on the infrared light spot sizes in the infrared light spot images to obtain the relationship curve between the infrared light spot size and an infrared sensing distance.

A self-decoupling three-dimensional force multimodal sensing method based on radial magnetization is implemented using the self-decoupling three-dimensional force multimodal sensing device based on radial magnetization described above. The method includes the following steps:
acquiring a leaked-light spot image captured by the visible-light camera and an infrared light spot image captured by the infrared camera;
calculating a position of a leaked-light spot center point in the leaked-light spot image on an imaging plane of the visible-light camera, and substituting a position of a current leaked-light spot center point on the imaging plane of the visible-light camera into a pre-stored relationship curve between a light spot center position and a force loading position, thereby obtaining a current force loading position;
calculating an infrared light spot size in the infrared light spot image, and substituting a current infrared light spot size into a pre-stored relationship curve between the infrared light spot size and an infrared sensing distance, thereby obtaining a current infrared sensing distance; and
decoupling a three-dimensional force according to the following formulas:

$${F}_{x} = \frac{S \cdot G}{k \cdot h} ( {tan}^{- 1} \frac{{R}_{xz} ( {x}_{i} ) - {b}_{1}}{{a}_{1}} - {tan}^{- 1} \frac{{R}_{xz} ( {x}_{0} ) - {b}_{1}}{{a}_{1}} )$$

$${F}_{y} = \frac{S \cdot G}{k \cdot h} ( {tan}^{- 1} \frac{{R}_{yz} ( {y}_{i} ) - {b}_{2}}{{a}_{2}} - {tan}^{- 1} \frac{{R}_{yz} ( {y}_{0} ) - {b}_{2}}{{a}_{2}} )$$

$${F}_{z} = \frac{S \cdot E}{k \cdot h} ln \frac{B ( {z}_{i} ) - {b}_{0}}{B ( {z}_{0} ) - {b}_{0}}$$

where Fₓ, F_{y} and F_{z} respectively denote forces in the x, y and z directions of the three-dimensional force, S denotes a contact area, G denotes a shear modulus, E denotes an elastic modulus, h denotes a distance from the upper surface of the flexible magnetic film to an upper surface of the PCB, k=2π/T denotes a wave number, T denotes a period, a₁, a₂ and b₀, b₁ and b₂ are pre-calibrated fitting coefficients, R_{xz}(xᵢ) and R_{xz}(x₀) respectively denote ratios of a magnetic flux density in an x direction to a magnetic flux density in a z direction when the flexible magnetic film is deformed to a position xᵢ under an x-direction force and when no force is applied, R_{yz}(yᵢ) and R_{yz}(y₀) respectively denote ratios of a magnetic flux density in a y direction to the magnetic flux density in the z direction when the flexible magnetic film is deformed to a position yᵢ under a y-direction force and when no force is applied, B(zᵢ) and B(z₀) respectively denote total magnetic flux densities when the flexible magnetic film is deformed to a position zᵢ under a z-direction force and when no force is applied, (x₀, y₀, z₀) denotes original coordinates of a center point of the flexible magnetic film when it is not subjected to a force, and (xᵢ, yᵢ, zᵢ) denotes coordinates of the center point of the flexible magnetic film after deformation under a three-dimensional force.

Compared with the prior art, the present disclosure has the beneficial effects:
1. In the present disclosure, a radially magnetized flexible magnetic film enables self-decoupling of normal force and shear force, without the need for complex calibration experiments to fit a decoupling model. By establishing a mathematical model between the magnetic flux density on the magnetic film and the normal force and shear force, decoupling of the normal force and the shear force is achieved.
2. In the present disclosure, the sensing device is capable of measuring the three-dimensional force. When a normal force is applied, local deformation occurs on a surface of the flexible magnetic film; and when a shear force is applied, tangential displacement of the flexible magnetic film occurs.
3. In the present disclosure, different measurement ranges and sensitivities can be achieved by changing microstructure layers with different elastic moduli and by adjusting a thickness of the flexible magnetic film.
4. In the present disclosure, the force application position is detected based on the total internal reflection method, and an infrared camera is used to measure an infrared distance between a human hand and a sensing device.
5. In the present disclosure, multimodal measurement of three-dimensional force, force position, and infrared distance can be realized.
6. In the present disclosure, different sensing units are adopted to perform multimodal sensing, without the need for a complex multimodal decoupling algorithm, making the structure simple and the application range wide.

### BRIEF DESCRIPTION OF THE DRAWINGS

FIG. 1 is a schematic structural diagram of a self-decoupling three-dimensional force multimodal sensing device based on radial magnetization according to an embodiment of the present disclosure.

FIG. 2 is a top view of a radially magnetized flexible magnetic film according to the present disclosure.

FIG. 3 is a schematic diagram of a magnetic field according to the present disclosure.

FIG. 4 is a schematic diagram of applying a normal force to a self-decoupling three-dimensional force multimodal sensing device according to the present disclosure.

FIG. 5 is a schematic diagram of applying a shear force to a self-decoupling three-dimensional force multimodal sensing device according to the present disclosure.

FIG. 6 is a schematic diagram of total internal reflection in an optical waveguide layer according to the present disclosure.

FIG. 7 is a schematic diagram of force position detection according to the present disclosure.

FIG. 8 is a schematic diagram of coordinate transformation according to the present disclosure.

FIG. 9 is a schematic diagram of infrared distance measurement according to the present disclosure.

### DESCRIPTION OF THE EMBODIMENTS

The technical solutions of embodiments of the present disclosure will be described below clearly and comprehensively with reference to accompanying drawings of the embodiments of the present disclosure.

### Embodiment 1

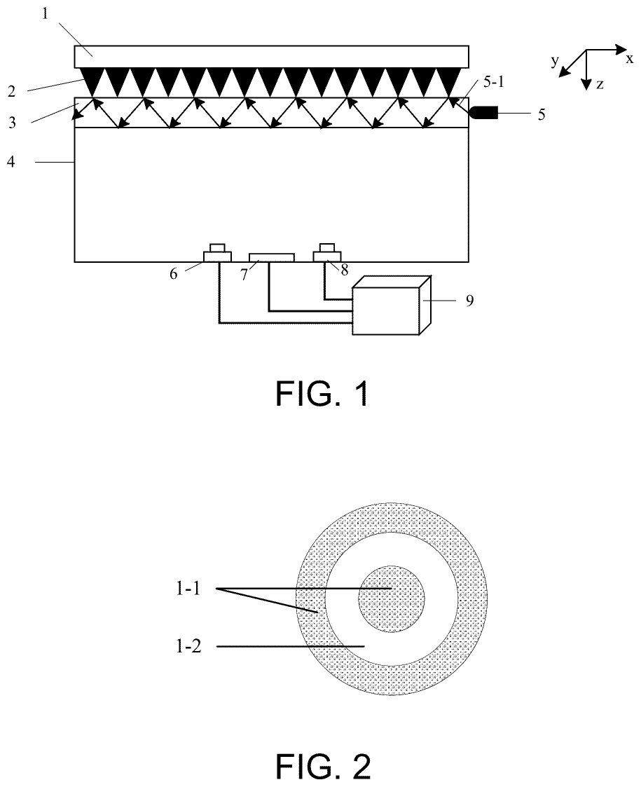

An embodiment of the present disclosure provides a self-decoupling three-dimensional force multimodal sensing device based on radial magnetization, as shown in FIG. 1. The device includes a flexible magnetic film 1 with radial magnetization, a microstructure layer 2, an optical waveguide layer 3, a housing 4, a visible-light camera 6, a Hall element (not shown in the figures), a printed circuit board (PCB) 7, and an infrared camera 8. Specifically, the flexible magnetic film 1, the microstructure layer 2, the optical waveguide layer 3, and the housing 4 are sequentially stacked from top to bottom. The PCB 7, the visible-light camera 6, and the infrared camera 8 are all located on a bottom surface of the housing 4, and the Hall element is mounted on the PCB 7. An LED light 5 serves as a light source, and light rays 5-1 emitted by the LED 5 undergo total internal reflection within the optical waveguide layer 3. Centers of the flexible magnetic film 1, the microstructure layer 2, and the optical waveguide layer 3 are aligned with a center of the Hall element along the same vertical line. The visible-light camera 6 and the infrared camera 8 are symmetrically arranged on opposite sides of the Hall element.

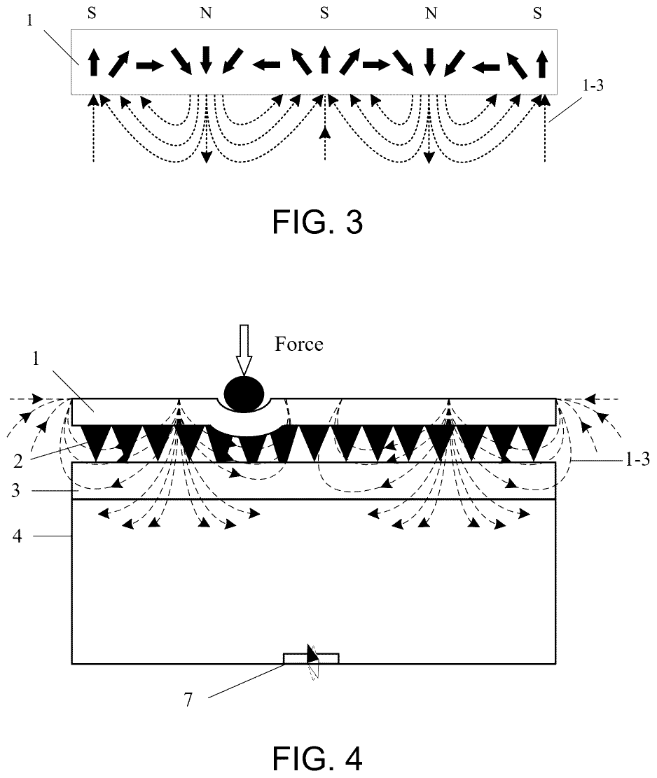

In a specific implementation mode, the flexible magnetic film 1 may be fabricated from a mixture of polydimethylsiloxane (PDMS) and neodymium-iron-boron (NdFeB) magnetic powder, with a thickness of 1 mm. After curing, the film is radially magnetized using a pulsed magnetizer. The radially magnetized flexible magnetic film 1 is shown in FIG. 2, in which a south (S) pole 1-1 and a north (N) pole 1-2 are distributed in radially spaced regions from an inside to an outside, and magnetic flux lines 1-3 of the flexible magnetic film 1 are distributed as shown in FIG. 3. The microstructure layer 2 is made of silicone rubber having a Shore A hardness of 70 and an inverted pyramid shape with a height of 1 mm. The optical waveguide layer 3 is made of polymethyl methacrylate (PMMA) and has a thickness of 1 mm. The flexible magnetic film 1 and the microstructure layer 2 are assembled together using an adhesive. The Hall element is a commercially available MLX90393 with adjustable sensitivity. In order to ensure consistent measurement ranges in an x direction and a y direction, a magnetic pole center of the flexible magnetic film 1 must be aligned with the center of the Hall element. The housing 4 is made of stainless steel and has a height of 5 mm. The visible-light camera 6 is configured to detect a position of an applied force, and the infrared camera 8 is configured to measure an infrared distance.

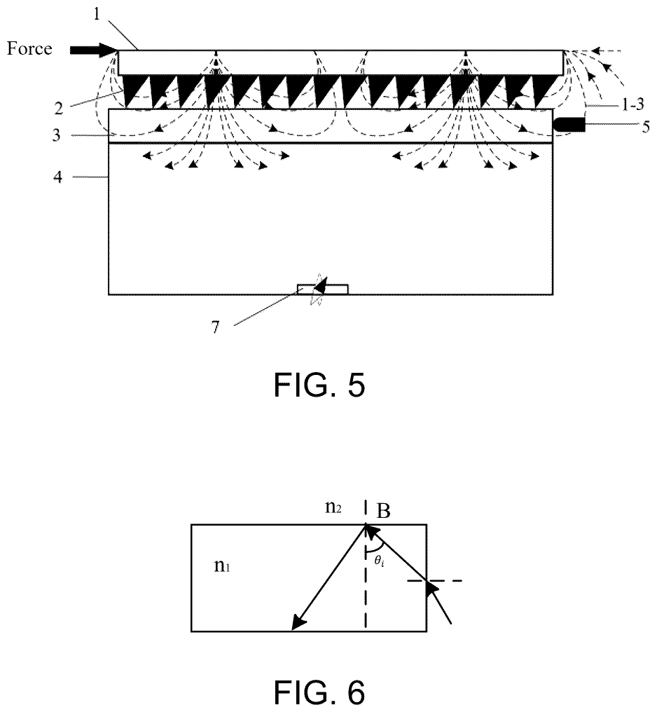

The working principle of this embodiment is as follows:
1. The flexible magnetic film 1 is magnetized using a radial magnetization method. When an external force is applied to the flexible magnetic film 1, the flexible magnetic film 1 undergoes a local deformation, causing a change in a magnetic flux density beneath the flexible magnetic film. The change is measured by the Hall element and converted into an electrical signal by the PCB 7. By analyzing and processing the electrical signal, magnitude and direction of a three-dimensional force may be decoupled and obtained;
2. after radial magnetization, the flexible magnetic film 1 has changes in a total magnetic flux density B(z), which is only associated with a force in a z direction. Changes in a ratio R_{xz} between a magnetic flux density in the x direction and a magnetic flux density in the z direction are only associated with a force in the x direction. Changes in a ratio R_{yz} between the magnetic flux density in the y direction and the magnetic flux density in the z direction are only associated with a force in the y direction;
3. when a force in the z direction is applied, a dent is formed in a contact region of the flexible magnetic film 1, and a magnetic flux density at a corresponding position change due to local deformation, as shown in FIG. 4. A mathematical model between the force in the z direction, a z-direction displacement and the total magnetic flux density B(z) is established. When a shear force in the x direction or the y direction is applied, as shown in FIG. 5, the flexible magnetic film 1 undergoes a corresponding displacement in the x direction or the y direction, causing a shift in a center position of the flexible magnetic film 1. Mathematical models are respectively established between the force in the x direction, an x-direction displacement and the magnetic flux density ratio R_{xz}, and between the force in the y direction, a y-direction displacement and the magnetic flux density ratio R_{yz}, thereby achieving three-dimensional force decoupling;
4. when the flexible magnetic film 1 is subjected to a force, the force is transmitted to the microstructure layer 2, causing the microstructure layer 2 to come into contact with the optical waveguide layer 3. A light spot, formed by leaked light 5-2, is generated in the contact region. The visible-light camera 6 captures the light spot, and a correspondence between a center position of the light spot and a position of the applied force is established, thereby enabling detection of the position of the applied force; and
5. when the flexible magnetic film 1 is located at different positions in the z direction, images captured by the infrared camera 8 are different. By establishing a correspondence between a size of an infrared light spot 8-1 and different positions in the z direction, infrared distance measurement may be achieved.

### Embodiment 2

An embodiment of the present disclosure provides a self-decoupling three-dimensional force multimodal sensing system based on radial magnetization, as shown in FIG. 1, in addition to the self-decoupling three-dimensional force multimodal sensing device based on radial magnetization described in Embodiment 1, the system further includes a signal processing device 9. The signal processing device 9 is connected to the visible-light camera 6, the PCB 7, and the infrared camera 8. The signal processing device specifically includes:
a data acquisition module configured to acquire a leaked-light spot image captured by the visible-light camera and an infrared light spot image captured by the infrared camera;
a force position acquisition module configured to calculate a position of a leaked-light spot center point in the leaked-light spot image on an imaging plane of the visible-light camera, and substitute a position of a current leaked-light spot center point on the imaging plane of the visible-light camera into a pre-stored relationship curve between a light spot center position and a force loading position, thereby obtaining a current force loading position;
an infrared distance sensing module configured to calculate an infrared light spot size in the infrared light spot image, and substitute a current infrared light spot size into a pre-stored relationship curve between the infrared light spot size and an infrared sensing distance, thereby obtaining a current infrared sensing distance; and
a three-dimensional force decoupling module configured to decouple a three-dimensional force according to the following formulas:

$${F}_{x} = \frac{S \cdot G}{k \cdot h} ( {tan}^{- 1} \frac{{R}_{xz} ( {x}_{i} ) - {b}_{1}}{{a}_{1}} - {tan}^{- 1} \frac{{R}_{xz} ( {x}_{0} ) - {b}_{1}}{{a}_{1}} )$$

$${F}_{y} = \frac{S \cdot G}{k \cdot h} ( {tan}^{- 1} \frac{{R}_{yz} ( {y}_{i} ) - {b}_{2}}{{a}_{2}} - {tan}^{- 1} \frac{{R}_{yz} ( {y}_{0} ) - {b}_{2}}{{a}_{2}} )$$

$${F}_{z} = \frac{S \cdot E}{k \cdot h} ln \frac{B ( {z}_{i} ) - {b}_{0}}{B ( {z}_{0} ) - {b}_{0}}$$

where Fₓ, F_{y} and F_{z} respectively denote forces in the x, y and z directions of the three-dimensional force, S denotes a contact area, G denotes a shear modulus, E denotes an elastic modulus, h denotes a distance from the upper surface of the flexible magnetic film to an upper surface of the PCB, k=2π/T denotes a wave number, T denotes a period, a₁, a₂ and b₀, b₁ and b₂ are pre-calibrated fitting coefficients, R_{xz}(xᵢ) and R_{xz}(x₀) respectively denote ratios of a magnetic flux density in an x direction to a magnetic flux density in a z direction when the flexible magnetic film is deformed to a position xᵢ under an x-direction force and when no force is applied, R_{yz}(yᵢ) and R_{yz}(y₀) respectively denote ratios of a magnetic flux density in a y direction to the magnetic flux density in the z direction when the flexible magnetic film is deformed to a position yᵢ under a y-direction force and when no force is applied, B(zᵢ) and B(z₀) respectively denote total magnetic flux densities when the flexible magnetic film is deformed to a position zᵢ under a z-direction force and when no force is applied, (x₀, y₀, z₀) denotes original coordinates of a center point of the flexible magnetic film when it is not subjected to a force, and (xᵢ, yᵢ, zᵢ) denotes coordinates of the center point of the flexible magnetic film after deformation under a three-dimensional force.

A derivation process of the decoupling formula for the three-dimensional force decoupling module is as follows:
in an x-y plane, the flexible magnetic film 1 has a thickness of d. Upper and lower surfaces of the flexible magnetic film 1 are defined as z=0 and z=d, respectively. Ideally, the radial magnetization pattern of the flexible magnetic film 1 is arranged as a superposition of two orthogonal sinusoidal curves in the x-y plane. Magnetic field components in the x, y, and z directions are respectively expressed as:

Mₓ=M₀ sin(kx)

M_{y}=M₀ sin(ky) (1)

M_{z}=0
where k=2π/T denotes a wave number, T denotes a period, and M₀ denotes a maximum amplitude of each component. Mₓ, M_{y} and M_{z} denote magnetic field components at coordinates (x, y, z).

The magnetic scalar potential inside the plane satisfies the Poisson equation, and the magnetic scalar potential outside the plane satisfies the Laplace equation. By solving the equations, the magnetic scalar potentials above, inside and below the magnetic film are expressed as follows:

$${φ}_{above} = 0$$

$${φ}_{inside} = \frac{{M}_{0}}{k} ( {e}^{kz} - 1 ) cos ( kx ) \qquad ( 2 )$$

$${φ}_{below} = \frac{{M}_{0}}{k} ( 1 - {e}^{kd} ) {e}^{kz} ( cos ( kx ) + cos ( ky ) )$$

where φ_{above} denotes a scalar magnetic potential above the flexible magnetic film, φ_{inside} denotes a scalar magnetic potential inside the flexible magnetic film, and φ_{below} denotes scalar magnetic potential below the flexible magnetic film.

A magnetic flux density B is proportional to a sum of a magnetic field H and a magnetization M, and the calculation formula for the magnetic flux density B is expressed as:

B=μ₀(H+M) (3)

where μ₀ is a magnetic permeability of free space and has a value of 4π×10⁻⁷ H·m⁻¹. Since a magnetization outside a magnetic material is zero, the magnetic flux densities below the flexible magnetic film 1 are obtained as follows:

$${B}_{x} = {μ}_{0} \frac{\partial {φ}_{below}}{\partial x} = - {μ}_{0} {M}_{0} ( 1 - {e}^{kd} ) {e}^{kz} sin ( kx ) \qquad ( 4 )$$

$${B}_{y} = {μ}_{0} \frac{\partial {φ}_{below}}{\partial y} = - {μ}_{0} {M}_{0} ( 1 - {e}^{kd} ) {e}^{kz} sin ( ky )$$

$${B}_{z} = {μ}_{0} \frac{\partial {φ}_{below}}{\partial z} = {μ}_{0} {M}_{0} ( 1 - {e}^{kd} ) {e}^{kz} ( cos ( kx ) + cos ( ky ) )$$

where Bₓ, B_{y} and B_{z} respectively denote the magnetic flux densities at coordinates (x, y, z) below the flexible magnetic film 1.

According to Formula (4), the magnetic flux density B(x, y, z) below a Halbach plane is calculated, and the magnetic field ratios R_{xz} and R_{yz} are calculated according to the following formulas:

$$B ( x , y , z ) = \sqrt{{B}_{x}^{2} + {B}_{y}^{2} + {B}_{z}^{2}} = {μ}_{0} {M}_{0} ( 1 - {e}^{kd} ) {e}^{kz} \sqrt{2 + 2 ( cos ( kx ) + cos ( ky ) )} \qquad ( 5 )$$

$${R}_{xz} = \frac{{B}_{x}}{{B}_{z}} = - \frac{sin ( kx )}{cos ( kx ) + cos ( ky )}$$

$${R}_{yz} = \frac{{B}_{y}}{{B}_{z}} = - \frac{sin ( ky )}{cos ( kx ) + cos ( ky )}$$

When displacement caused by an applied force is less than 1 mm, Formula (5) may be approximated as:

B(x,y,z)=a₀μ₀M₀(1−e^{kd})e^{kz}+b₀

R_{xz}=a₁ tan(kx)+b₁ (6)

R_{yz}=a₂ tan(ky)+b₂

where a₀, a₁, a₂ and b₀, b₁ and b₂ are pre-calibrated fitting coefficients obtained by fitting multiple data pairs. Accordingly, expressions of x, y, and z are as follows according to Formula (6):

$$x = \frac{1}{k} {tan}^{- 1} \frac{{R}_{xz} - {b}_{1}}{{a}_{1}}$$

$$y = \frac{1}{k} {tan}^{- 1} \frac{{R}_{yz} - {b}_{2}}{{a}_{2}}$$

$$z = \frac{1}{k} ln \frac{( B - {b}_{0} )}{{a}_{0} {μ}_{0} {M}_{0} ( 1 - {e}^{kd} )}$$

When the flexible magnetic film 1 is subjected to an external force, and the center point is deformed from the position (x₀, y₀, z₀) to the position (xᵢ, yᵢ, zᵢ), forces Fₓ, F_{y} and F_{z} in the x direction, y direction, and z directions are obtained as follows according to Hooke's Law:

$${F}_{x} = S \cdot ( G \cdot {γ}_{x} ) = S \cdot G \cdot \frac{Δ x}{h} \qquad ( 7 )$$

$${F}_{y} = S \cdot ( G \cdot {γ}_{y} ) = S \cdot G \cdot \frac{Δ y}{h}$$

$${F}_{z} = S \cdot ( G \cdot ε ) = S \cdot E \cdot \frac{Δ z}{h}$$

where S denotes a contact area; and γₓγ_{y}, ε, Δx, Δy, Δz G, E, and h denote strain in the x direction, strain in the y direction, strain in the z direction, deformation in the x direction, deformation in the y direction, deformation in the z direction, the shear modulus, the elastic modulus, and the distance from the upper surface of the flexible magnetic film to the upper surface of the PCB, respectively. A relationship between the shear modulus and the elastic modulus is expressed as:

$$G = \frac{E}{2 ( 1 + υ )} \qquad ( 8 )$$

where v is Poisson's ratio. Therefore, the following expressions are obtained:

$${F}_{x} = \frac{S \cdot G}{k \cdot h} ( {tan}^{- 1} \frac{{R}_{xz} ( {x}_{i} ) - {b}_{1}}{{a}_{1}} - {tan}^{- 1} \frac{{R}_{xz} ( {x}_{0} ) - {b}_{1}}{{a}_{1}} )$$

$${F}_{y} = \frac{S \cdot G}{k \cdot h} ( {tan}^{- 1} \frac{{R}_{yz} ( {y}_{i} ) - {b}_{2}}{{a}_{2}} - {tan}^{- 1} \frac{{R}_{yz} ( {y}_{0} ) - {b}_{2}}{{a}_{2}} )$$

$${F}_{z} = \frac{S \cdot E}{k \cdot h} ln \frac{B ( {z}_{i} ) - {b}_{0}}{B ( {z}_{0} ) - {b}_{0}}$$

Accordingly, it can be concluded that Fₓ is only associated with the deformation in the x direction and R_{xz}, F_{y} is only associated with the deformation in the y direction and R_{yz}, F_{z} is only associated with the deformation in the z direction and the total magnetic flux density B(z), When S, G, k and h are known, the present disclosure is capable of implementing three-dimensional force decoupling of Fₓ, F_{y} and F_{z}.

As shown in FIG. 6, when no external force is applied, the LED light serves as a light source, and total internal reflection occurs inside the optical waveguide layer 3. A refractive index n₁ of the optical waveguide layer is 1.49, and a refractive index of air n₂ is 1. At point B, according to Snell's law, it may be obtained as follows:

n₁ sin θᵢ=n₂ sin θₜ
where θᵢ is an incident angle, and θₜ is a refraction angle. When the refraction angle θₜ=90°, a critical incident angle may be obtained as:

$${θ}_{i} = {sin}^{- 1} \frac{{n}_{2}}{{n}_{1}} = 42.16 °$$

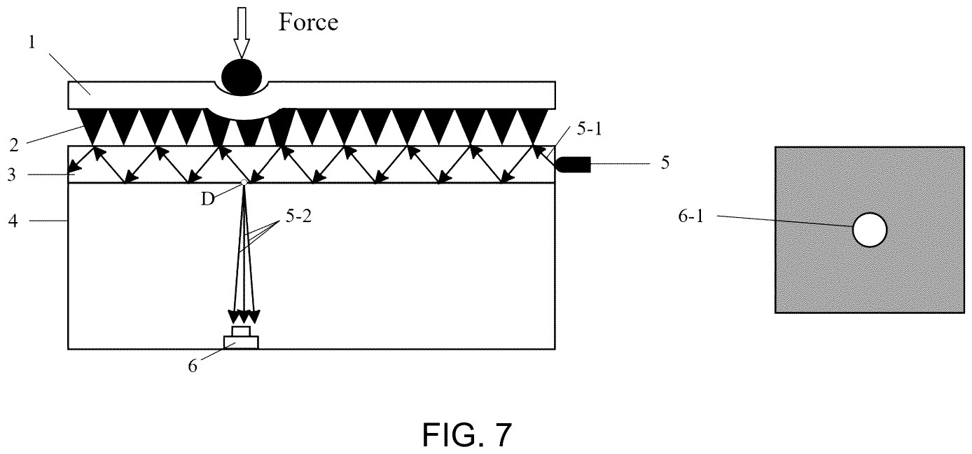

As shown in FIG. 7, when a force is applied to the flexible magnetic film 1, the microstructure layer 2 deforms and comes into contact with the optical waveguide layer 3. Because the conditions for total internal reflection are no longer satisfied in the contact region, leaked light is generated at Point D. A leaked-light spot image is obtained by the visible-light camera 6. A position of the applied force may be inversely determined according to a center position of the leaked-light spot 6-1.

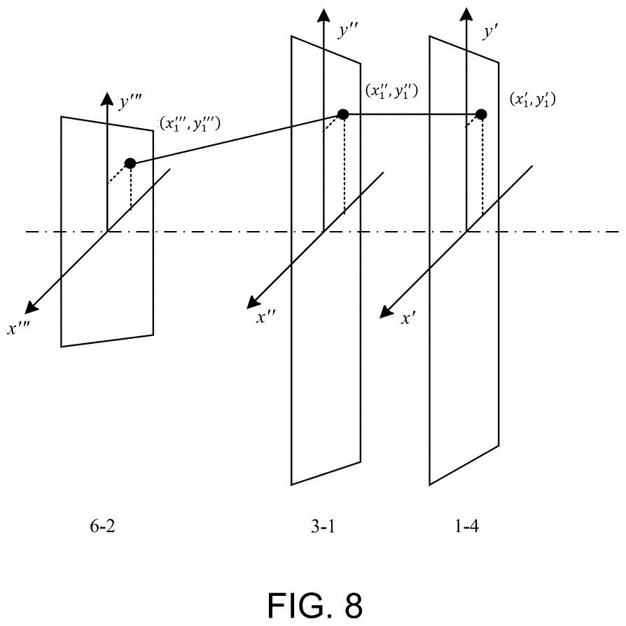

As shown in FIG. 8, assuming that a center position of an upper surface 1-4 of the flexible magnetic film 1 is taken as a coordinate origin, a coordinate system x′y′ is established. A force loading point on the upper surface 1-4 of the flexible magnetic film 1 is assumed to have coordinates

$$( {x}_{1}^{′} , {y}_{1}^{′} ) .$$

Since the length and width of the optical waveguide layer 3 and the flexible magnetic film 1 are the same, and their centers are aligned on the same line, similarly, a center position of a lower surface 3-1 of the optical waveguide layer 3 is also taken as a coordinate origin to establish a coordinate system x″y″. Accordingly, leaked light is generated at a corresponding position

$$( {x}_{1}^{″} , {y}_{1}^{″} )$$

of the optical waveguide layer 3, and a leaked-light spot is formed on the visible-light camera 6. Taking a center position of an imaging plane 6-2 of the visible-light camera 6 as a coordinate origin, a coordinate system x′″y′″ is established. By processing the leaked-light spot image and locating a center point of the leaked-light spot, coordinates x′″y′″ of the center point in the coordinate system

$$( {x}_{1}^{′′′} , {y}_{1}^{′′′} )$$

are obtained. A coordinate transformation curve between the coordinate system x′″y′″ and the coordinate system x′y′ is calculated and stored as a relationship curve f between the light spot center position and the force loading position. When the coordinates

$$( {x}_{1}^{′′′} , {y}_{1}^{′′′} )$$

are obtained, coordinates

$$( {x}_{1}^{′} , {y}_{1}^{′} ) = f ( {x}_{1}^{′′′} , {y}_{1}^{′′′} )$$

of the force loading point can be determined.

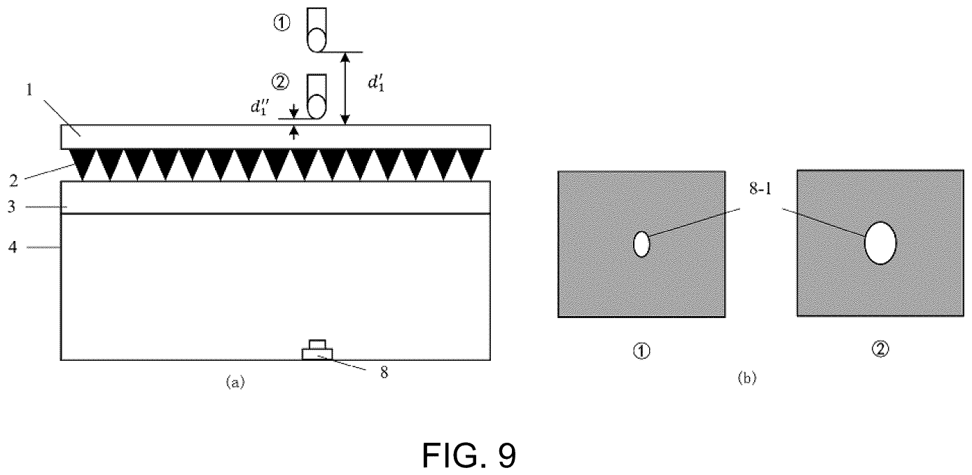

Every object with a temperature above absolute zero (−273.15° C.) emits electromagnetic radiation, a phenomenon known as thermal radiation. A normal human body temperature is approximately 36-37° C. (about 300 Kelvin). According to the blackbody radiation law, at such a temperature, electromagnetic radiation emitted by the human body is mainly in an infrared band (with wavelengths of approximately 700 nm-1 mm). When a human hand or another object with a certain temperature approaches the upper surface of the flexible magnetic film 1, as shown in (a) of FIG. 9, emitted infrared light may be captured by the infrared camera 8. (b) of FIG. 9 illustrates infrared light spot images of a human hand located at two different positions. By establishing a mathematical model between an infrared light spot size and a distance thereof, infrared distance measurement may be achieved. Specifically, infrared light spot sizes in the infrared light spot images at different distances may be calculated, and fitting is performed based on the infrared light spot sizes in the infrared light spot images to obtain the relationship curve between the infrared light spot size and an infrared sensing distance. For example, when a distance between a human hand and a position directly above the flexible magnetic film is d₁, and a diameter of an infrared light spot is L, a relationship curve G is then determined as: d₁=G(L).

It should be noted that, in the above embodiment of the system, various units and modules included are divided only according to functional logic, and are not limited to the divisions described above, as long as corresponding functions can be achieved. In addition, specific names of the functional units are provided only for ease of distinction and are not intended to limit the scope of protection of the present disclosure.

The embodiments described above are merely illustrative, where modules described as separate components may or may not be physically separated, and components shown as modules may or may not be physical modules, that is, they may be located at a single location or distributed across multiple network modules. Some or all of the modules may be selected according to actual needs to achieve the objectives of the embodiments. Those skilled in the art will clearly understand that various embodiments can be implemented using software in combination with necessary general-purpose hardware platforms, or can be implemented solely using hardware, as long as the corresponding functions or effects can be achieved.

### Embodiment 3

An embodiment of the present disclosure provides a self-decoupling three-dimensional force multimodal sensing method based on radial magnetization. The method is implemented using the self-decoupling three-dimensional force multimodal sensing device based on radial magnetization described in Embodiment 1. The method includes the following steps:
acquiring a leaked-light spot image captured by the visible-light camera and an infrared light spot image captured by the infrared camera;
calculating a position of a leaked-light spot center point in the leaked-light spot image on an imaging plane of the visible-light camera, and substituting a position of a current leaked-light spot center point on the imaging plane of the visible-light camera into a pre-stored relationship curve between a light spot center position and a force loading position, thereby obtaining a current force loading position;
calculating an infrared light spot size in the infrared light spot image, and substituting a current infrared light spot size into a pre-stored relationship curve between the infrared light spot size and an infrared sensing distance, thereby obtaining a current infrared sensing distance; and
decoupling a three-dimensional force according to the following formulas:

$${F}_{x} = \frac{S \cdot G}{k \cdot h} ( {tan}^{- 1} \frac{{R}_{xz} ( {x}_{i} ) - {b}_{1}}{{a}_{1}} - {tan}^{- 1} \frac{{R}_{xz} ( {x}_{0} ) - {b}_{1}}{{a}_{1}} )$$

$${F}_{y} = \frac{S \cdot G}{k \cdot h} ( {tan}^{- 1} \frac{{R}_{yz} ( {y}_{i} ) - {b}_{2}}{{a}_{2}} - {tan}^{- 1} \frac{{R}_{yz} ( {y}_{0} ) - {b}_{2}}{{a}_{2}} )$$

$${F}_{z} = \frac{S \cdot E}{k \cdot h} ln \frac{B ( {z}_{i} ) - {b}_{0}}{B ( {z}_{0} ) - {b}_{0}}$$

where Fₓ, F_{y} and F_{z} respectively denote forces in the x, y and z directions of the three-dimensional force, S denotes a contact area, G denotes a shear modulus, E denotes an elastic modulus, h denotes a distance from the upper surface of the flexible magnetic film to an upper surface of the PCB, k=2π/T denotes a wave number, T denotes a period, a₁, a₂ and b₀, b₁ and b₂ are pre-calibrated fitting coefficients, R_{xz}(xᵢ) and R_{xz} (x₀) respectively denote ratios of a magnetic flux density in an x direction to a magnetic flux density in a z direction when the flexible magnetic film is deformed to a position xᵢ under an x-direction force and when no force is applied, R_{yz}(yᵢ) and R_{yz}(y₀) respectively denote ratios of a magnetic flux density in a y direction to the magnetic flux density in the z direction when the flexible magnetic film is deformed to a position yᵢ under a y-direction force and when no force is applied, B(zᵢ) and B(z₀) respectively denote total magnetic flux densities when the flexible magnetic film is deformed to a position zᵢ under a z-direction force and when no force is applied, (x₀, y₀, z₀) denotes original coordinates of a center point of the flexible magnetic film when it is not subjected to a force, and (xᵢ, yᵢ, zᵢ) denotes coordinates of the center point of the flexible magnetic film after deformation under a three-dimensional force.

The method corresponds to the system of Embodiment 2. For details not explicitly mentioned herein, reference is made to Embodiment 1, and further explanation is omitted.

It should be understood that the above embodiments and specification illustrate only the principles, main features, and advantages of the present disclosure. Various modifications and improvements may be made to the present disclosure without departing from the spirit and scope thereof, and such modifications and improvements shall fall within the scope of protection of the present disclosure.

What is claimed is:

1. A self-decoupling three-dimensional force multimodal sensing device based on radial magnetization, comprising a flexible magnetic film with radial magnetization, a microstructure layer, an optical waveguide layer, a housing, a Hall element, a printed circuit board (PCB), a visible-light camera, and an infrared camera, wherein the flexible magnetic film, the microstructure layer, the optical waveguide layer, and the housing are sequentially stacked from top to bottom, the PCB, the visible-light camera, the infrared camera are all located on a bottom surface of the housing, and the Hall element is mounted on the PCB.

2. The self-decoupling three-dimensional force multimodal sensing device based on radial magnetization according to claim 1, wherein centers of the flexible magnetic film, the microstructure layer, and the optical waveguide layer are aligned with a center of the Hall element along the same vertical line.

3. The self-decoupling three-dimensional force multimodal sensing device based on radial magnetization according to claim 1, wherein the visible-light camera and the infrared camera are symmetrically arranged on opposite sides of the Hall element.

4. The self-decoupling three-dimensional force multimodal sensing device based on radial magnetization according to claim 1, wherein the flexible magnetic film is fabricated from polydimethylsiloxane (PDMS) and neodymium-iron-boron (NdFeB) magnetic powder.

5. The self-decoupling three-dimensional force multimodal sensing device based on radial magnetization according to claim 1, wherein the microstructure layer is made of silicone rubber with an inverted pyramid shape.

6. The self-decoupling three-dimensional force multimodal sensing device based on radial magnetization according to claim 1, wherein the optical waveguide layer is made of polymethyl methacrylate (PMMA).

7. A self-decoupling three-dimensional force multimodal sensing system based on radial magnetization, comprising the self-decoupling three-dimensional force multimodal sensing device according to claim 1 and a signal processing device, wherein the signal processing device comprises:
a data acquisition module configured to acquire a leaked-light spot image captured by the visible-light camera and an infrared light spot image captured by the infrared camera;
a force position acquisition module configured to calculate a position of a leaked-light spot center point in the leaked-light spot image on an imaging plane of the visible-light camera, and substitute a position of a current leaked-light spot center point on the imaging plane of the visible-light camera into a pre-stored relationship curve between a light spot center position and a force loading position, thereby obtaining a current force loading position;
an infrared distance sensing module configured to calculate an infrared light spot size in the infrared light spot image, and substitute a current infrared light spot size into a pre-stored relationship curve between the infrared light spot size and an infrared sensing distance, thereby obtaining a current infrared sensing distance; and
a three-dimensional force decoupling module configured to decouple a three-dimensional force according to the following formulas:
$${F}_{x} = \frac{S \cdot G}{k \cdot h} ( {tan}^{- 1} \frac{{R}_{xz} ( {x}_{i} ) - {b}_{1}}{{a}_{1}} - {tan}^{- 1} \frac{{R}_{xz} ( {x}_{0} ) - {b}_{1}}{{a}_{1}} )$$
$${F}_{y} = \frac{S \cdot G}{k \cdot h} ( {tan}^{- 1} \frac{{R}_{yz} ( {y}_{i} ) - {b}_{2}}{{a}_{2}} - {tan}^{- 1} \frac{{R}_{yz} ( {y}_{0} ) - {b}_{2}}{{a}_{2}} )$$
$${F}_{z} = \frac{S \cdot E}{k \cdot h} ln \frac{B ( {z}_{i} ) - {b}_{0}}{B ( {z}_{0} ) - {b}_{0}}$$
wherein Fₓ, F_{y} and F_{z} respectively denote forces in the x, y and z directions of the three-dimensional force, S denotes a contact area, G denotes a shear modulus, E denotes an elastic modulus, h denotes a distance from the upper surface of the flexible magnetic film to an upper surface of the PCB, k=2π/T denotes a wave number, T denotes a period, a₁, a₂ and b₀, b₁ and b₂ are pre-calibrated fitting coefficients, R_{xz}(xᵢ) and R_{xz}(x₀) respectively denote ratios of a magnetic flux density in an x direction to a magnetic flux density in a z direction when the flexible magnetic film is deformed to a position xᵢ under an x-direction force and when no force is applied, R_{yz}(yᵢ) and R_{yz}(y₀) respectively denote ratios of a magnetic flux density in a y direction to the magnetic flux density in the z direction when the flexible magnetic film is deformed to a position yᵢ under a y-direction force and when no force is applied, B(zᵢ) and B(z₀) respectively denote total magnetic flux densities when the flexible magnetic film is deformed to a position zᵢ under a z-direction force and when no force is applied, (x₀, y₀, z₀) denotes original coordinates of a center point of the flexible magnetic film when it is not subjected to a force, and (xᵢ, yᵢ, zᵢ) denotes coordinates of the center point of the flexible magnetic film after deformation under a three-dimensional force.

8. The self-decoupling three-dimensional force multimodal sensing system based on radial magnetization according to claim 7, wherein the relationship curve between a light spot center position and a force loading position is obtained according to the following method:
establishing a coordinate system x′y′ by taking a center position of the upper surface of the flexible magnetic film as a coordinate origin;
establishing a coordinate system x′″y′″ by taking a center position of the imaging plane of the visible-light camera as a coordinate origin; and
calculating a coordinate transformation curve between the coordinate system x′″y′″ and the coordinate system x′y′ and taking the same as the relationship curve between a light spot center position and a force loading position.

9. The self-decoupling three-dimensional force multimodal sensing system based on radial magnetization according to claim 7, wherein the relationship curve between the infrared light spot size and an infrared sensing distance is obtained according to the following method:
placing the same infrared sensing object at different distances from the upper surface of the flexible magnetic film, and acquiring infrared spot images when the infrared sensing object is placed;
calculating infrared light spot sizes in the infrared light spot images at different distances; and
performing fitting based on the infrared light spot sizes in the infrared light spot images to obtain the relationship curve between the infrared light spot size and an infrared sensing distance.

10. A self-decoupling three-dimensional force multimodal sensing method based on radial magnetization, wherein the method is implemented using the self-decoupling three-dimensional force multimodal sensing device based on radial magnetization according to claim 1, and comprises:
acquiring a leaked-light spot image captured by the visible-light camera and an infrared light spot image captured by the infrared camera;
calculating a position of a leaked-light spot center point in the leaked-light spot image on an imaging plane of the visible-light camera, and substituting a position of a current leaked-light spot center point on the imaging plane of the visible-light camera into a pre-stored relationship curve between a light spot center position and a force loading position, thereby obtaining a current force loading position;
calculating an infrared light spot size in the infrared light spot image, and substituting a current infrared light spot size into a pre-stored relationship curve between the infrared light spot size and an infrared sensing distance, thereby obtaining a current infrared sensing distance; and
decoupling a three-dimensional force according to the following formulas:
$${F}_{x} = \frac{S \cdot G}{k \cdot h} ( {tan}^{- 1} \frac{{R}_{xz} ( {x}_{i} ) - {b}_{1}}{{a}_{1}} - {tan}^{- 1} \frac{{R}_{xz} ( {x}_{0} ) - {b}_{1}}{{a}_{1}} )$$
$${F}_{y} = \frac{S \cdot G}{k \cdot h} ( {tan}^{- 1} \frac{{R}_{yz} ( {y}_{i} ) - {b}_{2}}{{a}_{2}} - {tan}^{- 1} \frac{{R}_{yz} ( {y}_{0} ) - {b}_{2}}{{a}_{2}} )$$
$${F}_{z} = \frac{S \cdot E}{k \cdot h} ln \frac{B ( {z}_{i} ) - {b}_{0}}{B ( {z}_{0} ) - {b}_{0}}$$
wherein Fₓ, F_{y} and F_{z} respectively denote forces in the x, y and z directions of the three-dimensional force, S denotes a contact area, G denotes a shear modulus, E denotes an elastic modulus, h denotes a distance from the upper surface of the flexible magnetic film to an upper surface of the PCB, k=2π/T denotes a wave number, T denotes a period, a₁, a₂ and b₀, b₁ and b₂ are pre-calibrated fitting coefficients, R_{xz}(xᵢ) and R_{xz}(x₀) respectively denote ratios of a magnetic flux density in an x direction to a magnetic flux density in a z direction when the flexible magnetic film is deformed to a position xᵢ under an x-direction force and when no force is applied, R_{yz}(yᵢ) and R_{yz}(y₀) respectively denote ratios of a magnetic flux density in a y direction to the magnetic flux density in the z direction when the flexible magnetic film is deformed to a position yᵢ under a y-direction force and when no force is applied, B(zᵢ) and B(z₀) respectively denote total magnetic flux densities when the flexible magnetic film is deformed to a position zᵢ under a z-direction force and when no force is applied, (x₀, y₀, z₀) denotes original coordinates of a center point of the flexible magnetic film when it is not subjected to a force, and (xᵢ, yᵢ, zᵢ) denotes coordinates of the center point of the flexible magnetic film after deformation under a three-dimensional force.
